(19) United States
(12) Patent Application Publication
(10) Pub. No.: US 2016/0080962 A1
(43) Pub. Date: Mar. 17, 2016

(54) WI-FI SIGNALING NETWORK INSIGHT DELIVERY

(71) Applicant: NOKIA SOLUTIONS AND NETWORKS OY, Espoo (FI)

(72) Inventors: John HARRIS, Glenview, IL (US); Umamaheswar KAKINADA, Carpentersville, IL (US); Maximilian RIEGEL, Nurnberg (DE)

(21) Appl. No.: 14/854,486

(22) Filed: Sep. 15, 2015

(30) Foreign Application Priority Data
Sep. 15, 2014 (EP) PCT/EP2014/069585

(51) Int. Cl. H04W 24/10; H04L 12/26

(52) U.S. Cl. CPC H04W 24/10; H04L 43/0882; H04W 84/12

(57) ABSTRACT

Systems, methods, apparatuses, and computer program products for Wi-Fi signaling network insight delivery are provided. One method includes detecting, for example by an application running on a wireless device, at least one Wi-Fi advertised value. The method may then include extracting, from the at least one Wi-Fi advertised value, at least one cellular network insight for a cellular network condition.

### FIELD

Embodiments may generally relate to communications systems, such as wireless communications networks, and may specifically relate to mechanisms for delivering network insights to a device, such as mobile or wireless device.

### BACKGROUND

Data analytics insights are transforming various industries by linking these insights with decisions. Network infrastructure generates network insights, for example, from the evolved node B (eNB), Radio Applications Cloud Server (RACS) and SAI/customer experience manager (CEM). These types of insights can be useful to many devices or elements of the network. For instance, this type of information can be useful to mobile applications, i.e., apps. As is known, an app may be considered to be a self-contained program or piece of software designed to fulfil a particular purpose, especially as downloaded by a user to a mobile device. Apps on mobile devices (e.g., smartphones, tablets, etc.) make many decisions, using nuanced and rapidly changing app knowledge. However, there is a need for a solution that provides easy access to insights that apps can use in their internal decisions.

### SUMMARY

One embodiment is directed to a method including detecting, by an application running on a wireless device, at least one Wi-Fi advertised value. The method may also include extracting, from the at least one Wi-Fi advertised value, at least one cellular network insight for a cellular network condition.

Another embodiment is directed to an apparatus including at least one processor and at least one memory including computer program code. The at least one memory and computer program code are configured, with the at least one processor, to cause the apparatus at least to detect at least one Wi-Fi advertised value, and to extract, from the at least one Wi-Fi advertised value, at least one cellular network insight for a cellular network condition.

Another embodiment is directed to a computer program, embodied on a computer readable medium. The computer program, when run on a processor, performs a method including detecting, by an application running on a wireless device, at least one Wi-Fi advertised value. The method may also include extracting, from the at least one Wi-Fi advertised value, at least one cellular network insight for a cellular network condition.

Another embodiment is directed to an apparatus including means for detecting at least one Wi-Fi advertised value. The apparatus may also include means for extracting, from the at least one Wi-Fi advertised value, at least one cellular network insight for a cellular network condition.

Another embodiment is directed to a method including detecting a first level of network congestion on a first wireless network. The method also includes, in response to the detecting of the first level of network congestion, transmitting a service set identifier (SSID) value over a second wireless network, where the SSID value encodes the first level of network congestion. The method may then include detecting a second level of network congestion on the first wireless network, and, in response to the detecting of the second level of network congestion, transmitting a second SSID value over the second wireless network, where the second SSID value encodes the second level of network congestion.

Another embodiment is directed to an apparatus including at least one processor and at least one memory including computer program code. The at least one memory and computer program code are configured, with the at least one processor, to cause the apparatus at least to detect a first level of network congestion on a first wireless network, and, in response to the detecting of the first level of network congestion, to transmit a service set identifier (SSID) value over a second wireless network, where the SSID value encodes the first level of network congestion. The apparatus may then be controlled to detect a second level of network congestion on the first wireless network, and, in response to the detecting of the second level of network congestion, to transmit a second SSID value over the second wireless network, wherein the second SSID value encodes the second level of network congestion.

Another embodiment is directed to a computer program, embodied on a computer readable medium. The computer program, when run on a processor, performs a method including detecting a first level of network congestion on a first wireless network. The method also includes, in response to the detecting of the first level of network congestion, transmitting a service set identifier (SSID) value over a second wireless network, where the SSID value encodes the first level of network congestion. The method may then include detecting a second level of network congestion on the first wireless network, and, in response to the detecting of the second level of network congestion, transmitting a second SSID value over the second wireless network, where the second SSID value encodes the second level of network congestion.

Another embodiment is directed to an apparatus including means for detecting a first level of network congestion on a first wireless network. The apparatus also includes, in response to the detecting of the first level of network congestion, means for transmitting a service set identifier (SSID) value over a second wireless network, where the SSID value encodes the first level of network congestion. The apparatus may then include means for detecting a second level of network congestion on the first wireless network, and, in response to the detecting of the second level of network congestion, means for transmitting a second SSID value over the second wireless network, where the second SSID value encodes the second level of network congestion.

Another embodiment is directed to an apparatus including means for detecting an authentication challenge value for the configuration or management of a first wireless network. The apparatus also includes, in response to the authentication challenge value, a means for transmitting a service set identifier (SSID) value over a second wireless network, where the SSID value encodes an authentication challenge value for the management on the first wireless network. The apparatus may then include means for detecting a second level of authentication challenge value on the first wireless network, and, in response to the detecting of the second authentication challenge value, means for transmitting a second SSID value over the second wireless network, where the second SSID value encodes the authentication challenge value.

### BRIEF DESCRIPTION OF THE DRAWINGS

For proper understanding of the invention, reference should be made to the accompanying drawings, wherein:

FIG. 1 illustrates a block diagram of an insight use example;

FIG. 2 illustrates a block diagram of an example of insight delivery to apps over the bearer path;

FIG. 3 illustrates an example of a generic advertisement service (GAS) messaging diagram;

FIG. 4 illustrates a block diagram of a system according to an example embodiment of the invention;

FIG. 5 illustrates a signaling diagram depicting an example of a method, according to one embodiment;

FIG. 6a illustrates a block diagram of an apparatus, according to an embodiment;

FIG. 6b illustrates a block diagram of an apparatus, according to another embodiment;

FIG. 7a illustrates a flow diagram of a method, according to an embodiment; and

FIG. 7b illustrates a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for Wi-Fi signaling network insight delivery, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

There are numerous use cases for apps to use insights in order to generate efficiency and monetization for both apps and network operators. As one example, consider an idle app that has decided to download some videos from the internet, but is flexible about the timing. Today, the app knows neither the local cell link speed (since it is idle) nor does it know the link speed in other cells. Thus, the app cannot find the fastest download opportunity, so it will download less opportunistically, for example likely finding 0.6 Mbps and spending a long time on channel and draining battery life. However, with Network Knowledge, the app would know when and where the least congested opportunity, using a Network Knowledge provided fastest cell ID or a push notification for the fastest download time. In this way, the app uses much less battery life (not 100% due to less time on channel, e.g. at 6 Mbps). The network operator benefits because downloading in this way also shifts the traffic out of congestion. There are many more examples, for example related to streaming, video telephony, gaming, user alerts, home screens, Wi-Fi or navigation. Network Knowledge supports essentially all insight use cases—with great simplicity.

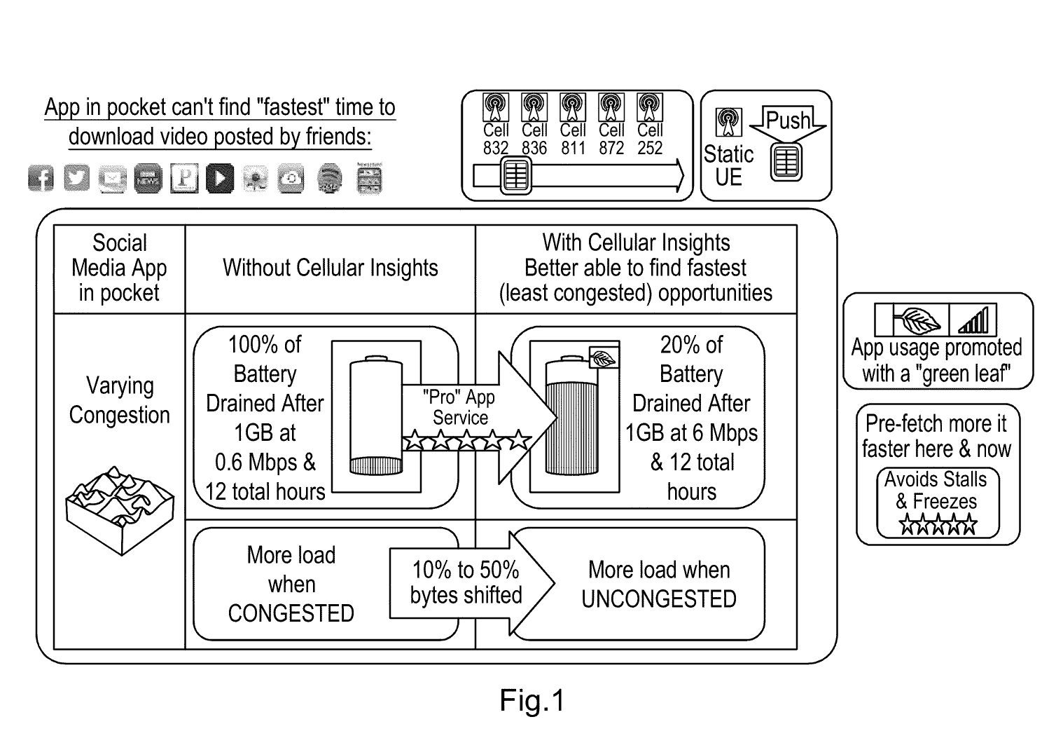

As mentioned above, there is a need for enabling networking insights to be easily accessed by apps so that those apps can make better decisions about when and how to take certain actions. FIG. 1 illustrates an insight use example. In this example, an app, such as a social networking app, may want to download videos or other information. Without access to network insights, the app may try to download the information during periods of high congestion resulting in longer download times and draining battery life. However, with access to cellular or network insights, the app can determine when there are periods of lower congestion and be able to perform its desired actions during those lower congestion periods thereby resulting in faster download times and saving battery life. It should be noted that FIG. 1 illustrates just one of many opportunities that may be created by apps utilizing cellular congestion insights. Many other examples and uses are possible.

In another example, an application may need to access an authentication challenge value in order to access the local management and configuration of a cellular access point. This authentication challenge value is an example of networking insight which can help this app make better decisions as to how to take this action.

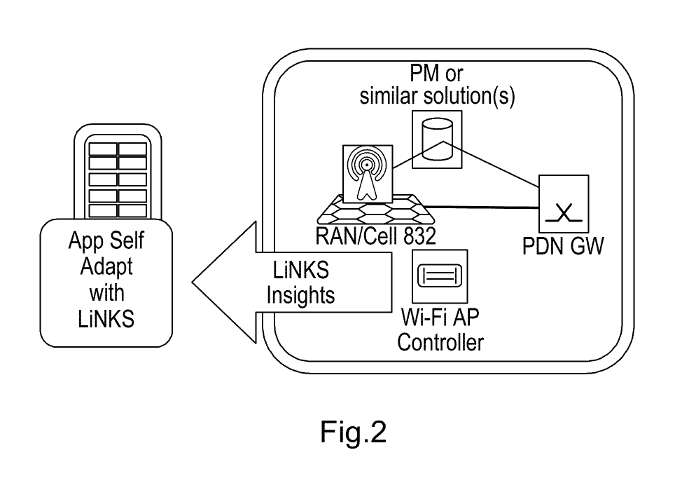

Cellular congestion insights can be delivered if the application activates the cellular modem, and sends and receives some information over the wireless link in order to connect the network insights with the app/application service provider. FIG. 2 illustrates an example of insight delivery to apps over the bearer path.

IEEE 802.11 provides two methods to deliver additional information elements to wireless devices without urging the wireless devices to authenticate with a Wi-Fi network. Information elements can either be provided by information elements included in the BEACONS, which are regularly transmitted broadcasts mainly containing the service set identifier (SSID), the homogeneous SSID (HESSID) in the case of an HS2.0 enabled Wi-Fi access and the basic SSID (BSSID) for providing an unique identifier for such access point, or by the Generic Advertisement Service running the access network query protocol (ANQP) introduced by IEEE 802.11u, which allows the provision of more comprehensive information as a response to a query by the wireless device before authentication.

As beacons have to be frequently broadcasted with most robust modulation and coding, the available space for additional information in the beacons is very limited to avoid waste of huge portions of the available spectrum.

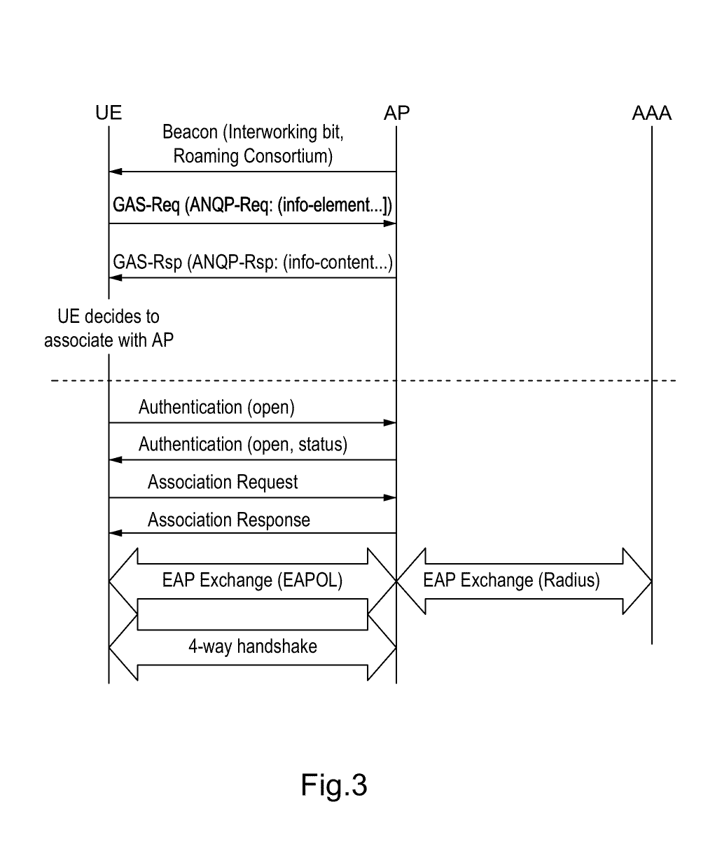

To overcome the limitations of broadcasting comprehensive information in the beacons the IEEE 802.11u provides a special protocol running in the pre-association phase, which can be used to actively query comprehensive information from the access network. Such service is currently limited to additional information regarding the Wi-Fi access point and may be extended by a recently established project IEEE 802.11aq for various service discovery protocols. FIG. 3 illustrates an example of a generic advertisement service (GAS) messaging diagram.

Embodiments of the invention provide for using a Wi-Fi advertised value of text, for example within the SSID field of Wi-Fi or Hot Spot 2.0 pre-association advertisement message, to convey cellular access specific network insights to apps running on smartphones, tablets, or other mobile or wireless devices. Embodiments of the invention also provide additional information on how to deploy the GAS/ANQP protocol discussed above to deliver cellular access specific network insights in accordance with service discovery protocols, such as 3GPP ANDSF protocol.

Therefore, one embodiment is configured to utilize existing Wi-Fi messages to broadcast cellular access specific network insights, to signal cellular access specific network insights without activating the cellular modem, and to connect the cellular access specific network insights with the application service provider without consuming additional Wi-Fi/cellular resources.

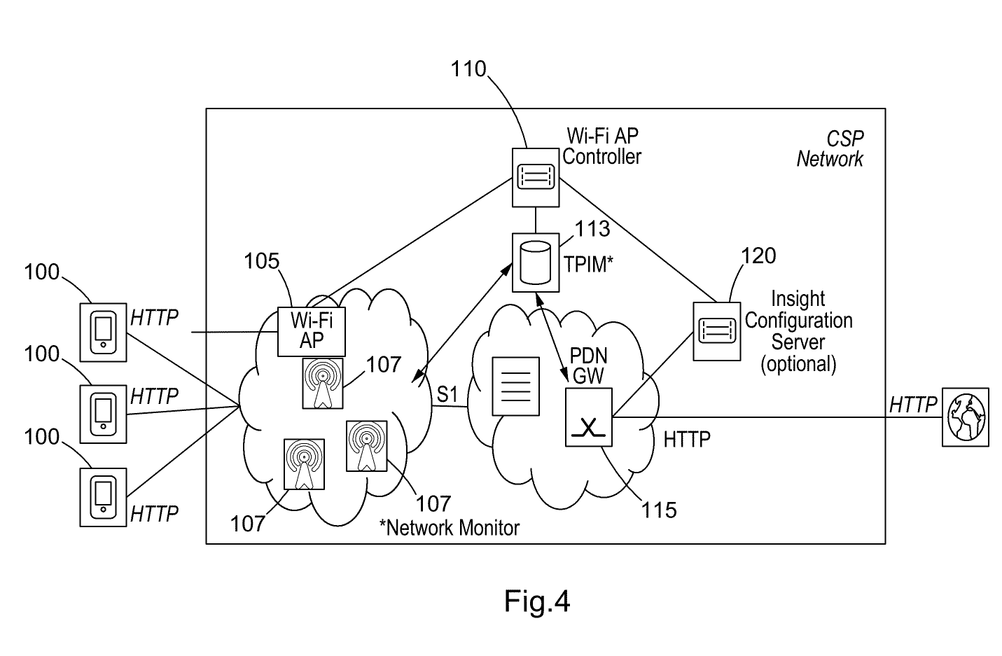

FIG. 4 illustrates a system according to an example embodiment of the invention. As illustrated in FIG. 4, the system may include one or more mobile devices 100 in communication with or being served by one or more (cellular) base stations 107 and/or one or more Wi-Fi access points (APs) 105. The base stations 107 and/or Wi-Fi access points (APs) 105 may be in communication with or connected to a core network including a packet data network gateway (PDN GW) 115, which in turn may be connected to the Internet or a wide area network (WAN), for example.

In an embodiment, as illustrated in FIG. 4, the base stations 107 and/or Wi-Fi access points (APs) 105 may be in communication with or connected to a performance information manager (PIM) or Network Monitor 113. In addition, the Wi-Fi access point may be literally integrated with the cellular access point further enabling this Network Monitoring communication embodiment. Similarly, the PDN GW 115 may also be in communication with or connected to the performance information manager 113. In certain embodiments, the performance information manager 113 may in turn be connected to a Wi-Fi AP controller 110 that controls Wi-Fi access points (APs) 105. Optionally, the PDN GW 115 may also be in communication with or connected to an insight configuration server 120, which may also be connected or in communication with the Wi-Fi AP controller 110.

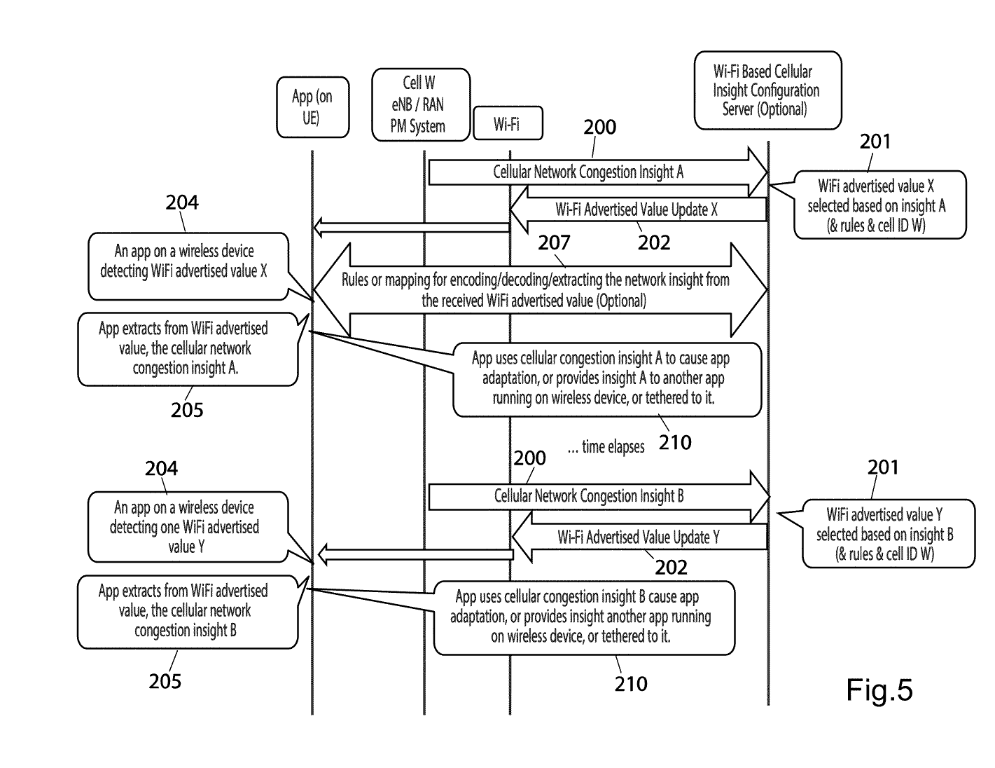

FIG. 5 illustrates a signaling diagram depicting an example of a method of orchestrating Wi-Fi systems in order to convey specific cellular network insights to devices (e.g., wireless devices) running one or more applications. The method may include, at step 200, the cellular network (e.g., eNB/RAN, performance management system/PIM) providing cellular network congestion insight to the Wi-Fi network or to a Wi-Fi based cellular insight configuration server. The method may then include, at step 202, providing a Wi-Fi advertised value update.

The method may also include, at step 204, the device (or an application running thereon) detecting at least one Wi-Fi advertised value. The method may also include, at step 205, extracting, from the at least one Wi-Fi advertised value, at least one network insight for a network condition.

In an embodiment, the at least one Wi-Fi advertised value is delivered to the wireless device within a Hot Spot 2.0 pre-association advertisement message. According to certain embodiments, the at least one Wi-Fi advertised value comprises a Wi-Fi SSID (e.g., HE SSID, HE SSID) name.

In some embodiments, the rules or mapping for encoding/decoding/extracting the network insight from the received Wi-Fi advertised value, which are exchanged at step 207, may be pre-provisioned onto the wireless device, or may be downloaded from at least one of a given Internet server, e.g., Network Knowledge server, ANDSF server, Hotspot 2.0 signaling, or 3GPP signaling, for example.

In other embodiments, the rules or mapping for encoding/decoding/extracting the network insight from the received Wi-Fi advertised value may include a function of other parameters including, for example, at least one of the current cell ID number, time of day, location, encryption key, and a seed. According to an example embodiment, the actual insight itself may be hashed or encrypted for example using the prevailing macro LTE cell ID number, and/or a separate encryption key. This can enable preventing apps that have not paid for access to the insights from being able to extract the insights. For example, apps which have not paid for access or full access to the insights will not have the encryption key such that the SSID will be opaque.

According to another embodiment, the rules or mapping for encoding/decoding/extracting the network insight from the received Wi-Fi advertised value may be such that the SSID value includes redundancy so that it can be signed and verified by the app detecting and decoding the SSID value. This may be similar to using forward error correction mechanisms or a long CRC-like field on the end of the SSID such that the app can verify that the SSID dissected is actually a valid SSID, which is actually conveying a network insight.

According to another embodiment, the App may leverage the Wi-Fi Hotspot 2.0 pre-association process to verify that the SSID received can be trusted and decoded to extract the cellular condition insight.

Returning to FIG. 5, in an embodiment, the wireless device (or an application running thereon), at step 210, may use the value of the extracted network insight to cause at least one application adaptation and/or to provide the insight to at least one other application running on the wireless device, or tethered to the wireless device. In an embodiment, the network condition encoded in the SSID or the pre-association signaling may include at least one of network conditions one or a plurality of cellular communication links.

According to an embodiment, a network node, such as a Wi-Fi based cellular insight configuration server, may be configured to perform a method that includes detecting a first level of cellular network congestion on a first cellular wireless network. In response to this detection, the network node may convey an SSID text value over a 2nd wireless network (e.g., a Wi-Fi network). The SSID text value may have encoded the detected 1st level of wireless network congestion. In addition, the network node may further detect a 2nd level of network congestion on a first wireless network. In response to this detection, the network node may convey a 2nd SSID text value over a 2nd wireless network. This 2nd SSID text value may have encoded the 2nd level of wireless network congestion.

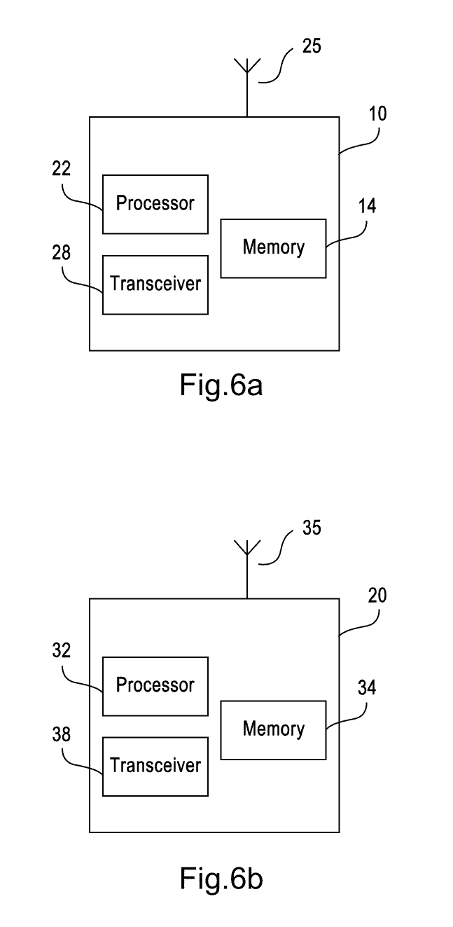

FIG. 6a illustrates an example of an apparatus 10 according to an embodiment. In an embodiment, apparatus 10 may be a node or element in or associated with one or more communications networks or being served by communications network(s). For example, in one embodiment apparatus 10 may be a mobile device, wireless device, or user equipment (UE), such as a mobile phone, smartphone, tablet, laptop, or other device capable of wireless communication. It should be noted that one of ordinary skill in the art would understand that apparatus 10 may include components or features not shown in FIG. 6a.

As illustrated in FIG. 6a, apparatus 10 includes a processor 22 for processing information and executing instructions or operations. Processor 22 may be any type of general or specific purpose processor. While a single processor 22 is shown in FIG. 6a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be a UE or mobile device, as discussed above. In this embodiment, apparatus 10 may be controlled by memory 14 and processor 22 to detect at least one Wi-Fi advertised value, and to extract, from the at least one Wi-Fi advertised value, at least one cellular network insight for a cellular network condition. According to an embodiment, apparatus 10 may be controlled by memory 14 and processor 22 to receive the at least one Wi-Fi advertised value within a Hot Spot 2.0 pre-association advertisement message. In one embodiment, the at least one Wi-Fi advertised value may include at least one Wi-Fi SSID name.

According to certain embodiments, the rules for the extracting of the cellular network insight from the at least one Wi-Fi advertised value may be pre-provisioned onto the apparatus 10 or may be downloaded from at least one of an internet server, an access network discovery and selection function (ANDSF) server, Hotspot 2.0 signaling, or third generation partnership project (3GPP) signaling, for example.

In some embodiments, rules for the extracting of the cellular network insight from the at least one Wi-Fi advertised value may be a function of other parameters including, for example, current cell ID number, time of day, location, encryption key, and/or a seed.

According to an embodiment, the SSID value comprises redundancy such that the SSID value is signed and verified by an application running on the apparatus 10.

According to an embodiment, apparatus 10 may be controlled by memory 14 and processor 22 to use the extracted at least one cellular network insight to cause at least one application adaptation or to provide the at least one cellular network insight to at least one other application running on the apparatus 10 or tethered to the apparatus 10. In one embodiment, the cellular network condition encoded in the at least one cellular network insight may include network conditions and/or a plurality of cellular communication links.

In certain embodiments, the network condition can include an indication of the likely per user throughput encountered over cellular if an additional user were to connect over cellular. In yet another embodiment, the Wi-Fi SSID may solely be used for conveying the cellular network condition, and is not used for carrying network bearer traffic.

FIG. 6b illustrates an example of an apparatus 20 according to another embodiment. In an embodiment, apparatus 20 may be a node, host, or server in a communications network or serving such a network, such as a configuration server. It should be noted that one of ordinary skill in the art would understand that apparatus 20 may include components or features not shown in FIG. 6b.

As illustrated in FIG. 6b, apparatus 20 includes a processor 32 for processing information and executing instructions or operations. Processor 32 may be any type of general or specific purpose processor. While a single processor 32 is shown in FIG. 6b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 further includes a memory 34, which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

Apparatus 20 may also include one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a server in a communications network, such as a Wi-Fi based cellular insight configuration server. In this embodiment, apparatus 20 may be controlled by memory 34 and processor 32 to detect a first level of network congestion on a first wireless network, such as a cellular network. In response to the detecting of the first level of network congestion, apparatus 20 may be controlled by memory 34 and processor 32 to transmit a SSID value over a second wireless network, such as a Wi-Fi network. The SSID value may encode the first level of network congestion. Apparatus 20 may then be controlled by memory 34 and processor 32 to detect a second level of network congestion on the first wireless network. In response to the detecting of the second level of network congestion, apparatus 20 may be controlled by memory 34 and processor 32 to transmit a second SSID value over the second wireless network. The second SSID value may encode the second level of network congestion.

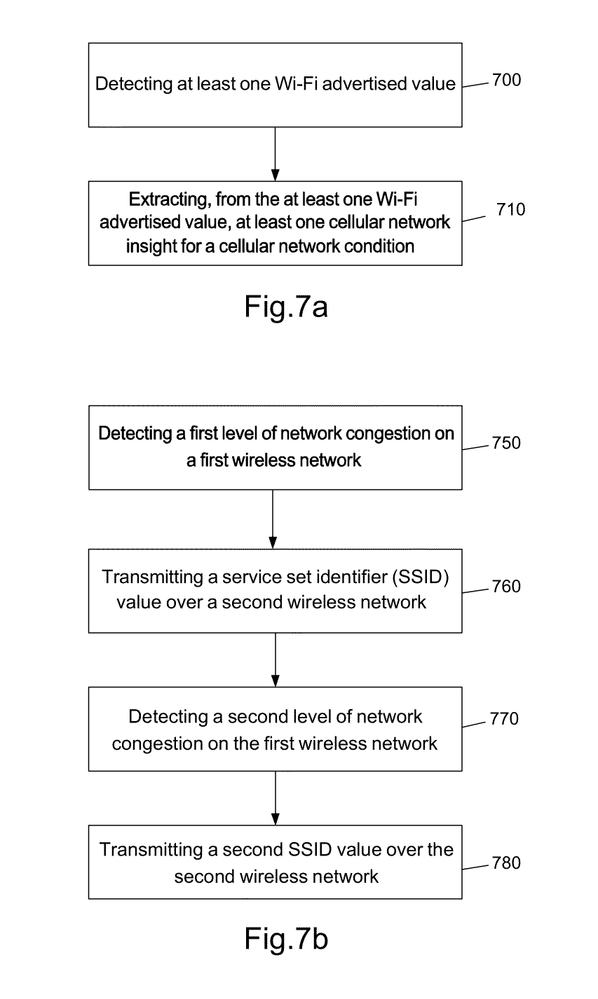

FIG. 7a illustrates an example of a flow diagram of method for configuring and/or controlling Wi-Fi networks to convey specific cellular network insights to applications running on a device, according to one embodiment. In an embodiment, the method may be performed, for instance, by a wireless device (or by an application running on a wireless device). The method may include, at 700, detecting one or more Wi-Fi advertised value(s). The method may then include, at 710, extracting, from the Wi-Fi advertised value(s), one or more cellular network insight(s) for a condition of cellular network, such as cellular network congestion.

FIG. 7b illustrates an example of a flow diagram of method for configuring and/or controlling Wi-Fi networks to convey specific cellular network insights to applications running on a device, according to another embodiment. In an embodiment, the method of FIG. 7b may be performed by a server or host in a communications network. The method may include, at 750, detecting a first level of network congestion on a first wireless network. In response to the detecting of the first level of network congestion, the method may also include, at 760, transmitting a service set identifier (SSID) value over a second wireless network. The SSID value may encode the first level of network congestion. The method may then include, at 770, detecting a second level of network congestion on the first wireless network. In response to the detecting of the second level of network congestion, the method may also include, at 780, transmitting a second SSID value over the second wireless network. The second SSID value may encode the second level of network congestion.

In some embodiments, the functionality of any of the methods described herein, such as those illustrated in FIGS. 7a and 7b discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

In view of the above, embodiments enable conveying insights directly to applications, while avoiding the need for the application to actually connect to the wireless network in order to retrieve updated wireless network insights. In addition, this does not require modifications to application servers.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
detecting, by an application running on a wireless device, at least one Wi-Fi advertised value; and
extracting, from the at least one Wi-Fi advertised value, at least one cellular network insight for a cellular network condition.

2. The method according to claim 1, wherein the at least one Wi-Fi advertised value is received by the wireless device within a hot spot 2.0 pre-association advertisement message.

3. The method according to claim 1, wherein the at least one Wi-Fi advertised value comprises a Wi-Fi service set identifier (SSID) name.

4. The method according to claim 1, wherein rules for the extracting of the cellular network insight from the at least one Wi-Fi advertised value are pre-provisioned onto the wireless device or are downloaded from at least one of an internet server, an access network discovery and selection function (ANDSF) server, Hotspot 2.0 signaling, or third generation partnership project (3GPP) signaling, or wherein rules for the extracting of the cellular network insight from the at least one Wi-Fi advertised value are a function of other parameters comprising at least one of current cell ID number, time of day, location, encryption key, or a seed.

5. The method according to claim 3, wherein the SSID value comprises redundancy such that the SSID value is signed and verified by the application running on the wireless device.

6. The method according to claim 1, further comprising using the extracted at least one cellular network insight to cause at least one application adaptation or to provide the at least one cellular network insight to at least one other application running on the wireless device or tethered to the wireless device.

7. The method according to claim 1, wherein the cellular network condition encoded in the at least one cellular network insight comprises a plurality of cellular communication links.

8. The method of claim 1, wherein the cellular network condition encoded in the at least one cellular network insight conveys that the condition corresponds to specific cellular network access point and that the condition conveys at least one of a cellular access point congestion condition or an expected cellular network throughput condition, or conveys an authentication challenge value for management of a specific cellular network access point.

9. An apparatus, comprising:
at least one processor; and
at least one memory including computer program code,
the at least one memory and computer program code configured, with the at least one processor, to cause the apparatus at least to
detect at least one Wi-Fi advertised value; and
extract, from the at least one Wi-Fi advertised value, at least one cellular network insight for a cellular network condition.

10. The apparatus according to claim 9, wherein the at least one Wi-Fi advertised value is received by the apparatus within a hot spot 2.0 pre-association advertisement message.

11. The apparatus according to claim 9, wherein the at least one Wi-Fi advertised value comprises a Wi-Fi service set identifier (SSID) value.

12. The apparatus according to claim 9, wherein rules for the extracting of the cellular network insight from the at least one Wi-Fi advertised value are pre-provisioned onto the apparatus or are downloaded from at least one of an internet server, an access network discovery and selection function (ANDSF) server, Hotspot 2.0 signaling, or third generation partnership project (3GPP) signaling.

13. The apparatus according to claim 9, wherein rules for the extracting of the cellular network insight from the at least one Wi-Fi advertised value are a function of other parameters comprising at least one of current cell ID number, time of day, location, encryption key, or a seed.

14. The apparatus according to claim 11, wherein the SSID value comprises redundancy such that the SSID value is signed and verified by an application running on the apparatus.

15. The apparatus according to claim 9, wherein the at least one memory and computer program code are further configured, with the at least one processor, to cause the apparatus at least to use the extracted at least one cellular network insight to cause at least one application adaptation or to provide the at least one cellular network insight to at least one other application running on the apparatus or tethered to the apparatus.

16. The apparatus according to claim 9, wherein the cellular network condition encoded in the at least one cellular network insight comprises at least one of network conditions or a plurality of cellular communication links.

17. The apparatus of claim 9, wherein the cellular network condition encoded in the at least one cellular network insight conveys that the condition corresponds to a specific cellular network access point and that the condition conveys at least one of a cellular access point congestion condition or an expected cellular network throughput condition.

18. The apparatus of claim 9, wherein the cellular network condition encoded in the at least one cellular network insight conveys an authentication challenge value for management of a specific cellular network access point.

19. An apparatus, comprising:
at least one processor; and
at least one memory including computer program code,
the at least one memory and computer program code configured, with the at least one processor, to cause the apparatus at least to
detect a first level of network congestion on a first wireless network;
in response to the detecting of the first level of network congestion, transmit a service set identifier (SSID) value over a second wireless network, wherein the SSID value encodes the first level of network congestion;
detect a second level of network congestion on the first wireless network; and
in response to the detecting of the second level of network congestion, transmit a second SSID value over the second wireless network, wherein the second SSID value encodes the second level of network congestion.

20. The apparatus according to claim 19, wherein the first wireless network comprises a cellular wireless network, and wherein the second wireless network comprises a Wi-Fi network.
